(19) United States
(12) Patent Application Publication
(10) Pub. No.: US 2026/0118961 A1
(43) Pub. Date: Apr. 30, 2026

(54) DETECTING ADVERSE HAPTIC ENVIRONMENTS

(71) Applicant: Google LLC, Mountain View, CA (US)

(72) Inventor: Philip Quinn, San Jose, CA (US)

(21) Appl. No.: 19/116,749

(22) PCT Filed: Oct. 10, 2022
(86) PCT No.: PCT/US2022/077861

§ 371 Date: Mar. 28, 2025

(51) Int. Cl. G06F 3/01; G06F 1/16; G06F 3/16

(52) U.S. Cl. CPC G06F 3/016; G06F 1/1694; G06F 3/167

(57) ABSTRACT

A computing device may drive a haptic device of the computing device to output a precursor haptic signal. The computing device may determine a motion signal associated with outputting the precursor haptic signal, lire computing device may determine, based at least in part on the motion signal associated with outputting the precursor haptic signal, that the computing device is in an adverse haptic environment. The computing device may, in response to determining that the computing device is in an adverse haptic environment, drive, by the one or more processors, the haptic device to output an alternative haptic signal instead of the haptic signal.

### BACKGROUND

A computing device may include a haptic device that applies forces, vibrations, or motions to the computing device to output a haptic signal, which is a vibratory response that can be felt by the user of the computing device. For example, a computing device may output a haptic signal that causes the computing device to vibrate when the computing device receives a phone call or receives a notification. Similarly, a computing device may output haptic signals to provide localized vibratory feedback when a user interacts with a virtual keyboard being displayed by the computing device to input text using the virtual keyboard.

### SUMMARY

In general, aspects of this disclosure are directed to techniques for determining whether a computing device is in an adverse haptic environment, which is an environment in which the computing device is likely to, when outputting a haptic signal to provide haptic feedback, rattle against one or more surfaces to produce undesirable harsh rattling noises. If the computing device determines that the computing device is in such an adverse haptic environment, the computing device may output an alternative haptic signal that may have one or more characteristics that may reduce the amount of an undesirable harsh rattling noise produced by the computing device.

To determine whether the computing device is in an adverse haptic environment, the computing device may output, for a short duration, a test haptic signal having a very low vibration intensity, and the computing device may measure the movement of the computing device as a result of outputting the test haptic signal. The computing device may, based on the movement of the computing device as a result of outputting the test haptic signal, determine whether the computing device is in an adverse haptic environment. If the computing device determines that the computing device is in an adverse haptic environment, the computing device may output an alternative haptic signal that may have one or more characteristics that may reduce the amount of an undesirable harsh rattling noise produced by the computing device.

The techniques of this disclosure may provide one or more technical advantages and solve one or more technical problems. By detecting whether the computing device is in an adverse haptic environment, the computing device may adaptively select the haptic signal that is outputted to reduce rattling of the computing device against one or more hard surfaces. Reducing the rattling of the computing device against one or more hard surfaces may reduce any harsh unpleasant rattle noises produced as a result of outputting the haptic signal but may also, in situations where the computing device is placed on a table having a hard surface, prevent the computing device and/or components of computing device (e.g., camera lens of the computing device) from potentially being damaged (e.g., scratched or dented) and/or potentially rattling off of the table. Reducing the rattling of the computing device against one or more hard surfaces may also, in some circumstances, reduce any unintentional or erroneous user input that may be caused by the unexpected harsh rattling and therefore sudden movement of the computing device as the user is attempting to provide user input at the computing device. In this way, the techniques of this disclosure may reduce the probability of damaging the computing device as a result of outputting haptic signals and may reduce erroneous user input at the computing device as a result of outputting haptic signals.

Furthermore, the techniques of this disclosure may enable computing device 102 to reduce power consumption. Because outputting a haptic signal having a relatively higher vibration intensity may consume more power than outputting a haptic signal having a relatively lower vibration intensity, outputting an alternative haptic signal having a relatively lower vibration intensity when computing device 102 is in an adverse haptic environment instead of a haptic signal having a relatively higher vibration intensity may reduce power consumption, thereby extending the battery life of mobile computing devices such as smart phones.

In some aspects, the techniques described herein relate to a method including: driving, by one or more processors of a computing device, a haptic device of the computing device to output a precursor haptic signal; determining, by the one or more processors, a motion signal associated with outputting the precursor haptic signal; determining, by the one or more processors and based at least in part on the motion signal associated with outputting the precursor haptic signal, that the computing device is in an adverse haptic environment; and in response to determining that the computing device is in the adverse haptic environment, driving, by the one or more processors, the haptic device to output an alternative haptic signal instead of the haptic signal.

In some aspects, the techniques described herein relate to a computing device including: a haptic device; a memory that stores instructions; and one or more processors that execute the instructions to: drive the haptic device to output a precursor haptic signal; determine a motion signal associated with outputting the precursor haptic signal; determine, based at least in part on the motion signal associated with outputting the precursor haptic signal, that the computing device is in an adverse haptic environment; and in response to determining that the computing device is the an adverse haptic environment, drive the haptic device to output an alternative haptic signal instead of a haptic signal.

In some aspects, the techniques described herein relates to an apparatus that includes means for driving a haptic device of the computing device to output a precursor haptic signal; means for determining a motion signal associated with outputting the precursor haptic signal; means for determining, based at least in part on the motion signal associated with outputting the precursor haptic signal, that the computing device is in an adverse haptic environment; and means for, in response to determining that the computing device is in the adverse haptic environment, driving the haptic device to output an alternative haptic signal instead of a haptic signal.

In some aspects, the techniques described herein relate to a non-transitory computer-readable storage medium storing instructions that, when executed, cause one or more processors of a computing device to: drive a haptic device of the computing device to output a precursor haptic signal; determine a motion signal associated with outputting the precursor haptic signal; determine, based at least in part on the motion signal associated with outputting the precursor haptic signal, that the computing device is in an adverse haptic environment; and in response to determining that the computing device is in the adverse haptic environment, drive the haptic device to output an alternative haptic signal instead of a haptic signal.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a conceptual diagram illustrating an example computing device configured to output a haptic signal, in accordance with one or more aspects of the present disclosure.

FIG. 2 is a block diagram illustrating an example computing device, in accordance with one or more aspects of the present disclosure.

FIG. 3 is a conceptual diagram illustrating an example precursor haptic signal outputted by an example haptic device.

FIG. 4 is a conceptual diagram that illustrates an example motion sensor response when an example haptic device outputs an example precursor haptic signal in a non-adverse haptic environment.

FIG. 5 is a conceptual diagram that illustrates an example motion sensor response when an example haptic device outputs an example precursor haptic signal in an adverse haptic environment.

FIG. 6 is a conceptual diagram that illustrates the example motion signal of FIG. 4 transformed from the time domain into the frequency domain.

FIG. 7 is a conceptual diagram that illustrates the example motion signal of FIG. 5 transformed from the time domain into the frequency domain.

FIG. 8 is a flowchart illustrating example operations of an example computing device configured to output haptic signals, in accordance with one or more aspects of the present disclosure.

### DETAILED DESCRIPTION

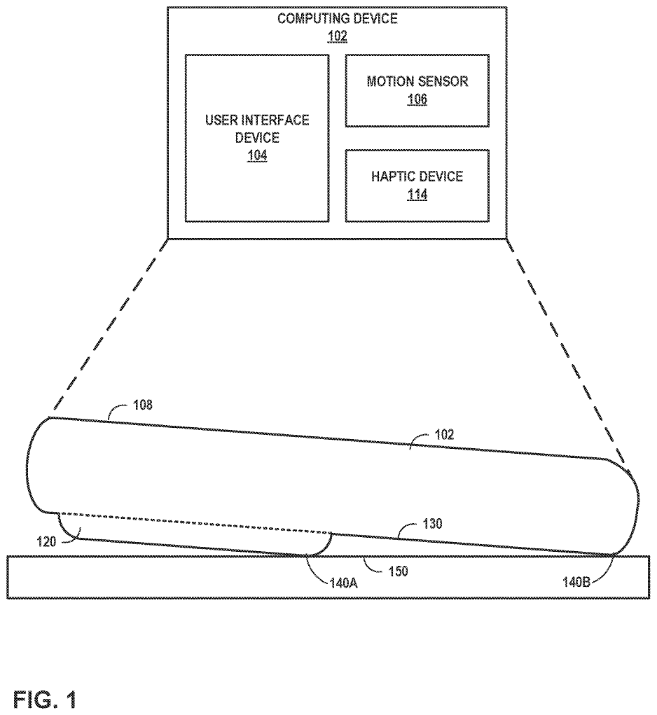

FIG. 1 is a conceptual diagram illustrating an example computing device 102 configured to output a haptic signal, in accordance with one or more aspects of the present disclosure. As shown in FIG. 1, computing device 102 is a mobile computing device (e.g., a mobile phone). However, in other examples, computing device 102 may be a tablet computer, a laptop computer, a desktop computer, a gaming system, a media player, an e-book reader, a television platform, an automobile navigation system, a wearable computing device (e.g., a computerized watch, computerized eyewear, a computerized glove), or any other type of mobile or non-mobile computing device.

Computing device 102 includes a user interface device (UID) 104. UID 104 of computing device 102 may function as an input device for computing device 102 and as an output device for computing device 102. UID 104 may be implemented using various technologies. For instance, UID 104 may function as an input device using a presence-sensitive input screen, such as a resistive touchscreen, a surface acoustic wave touchscreen, a capacitive touchscreen, a projective capacitive touchscreen, a pressure sensitive screen, an acoustic pulse recognition touchscreen, or another presence-sensitive display technology. UID 104 may function as an output (e.g., display) device using any one or more display devices, such as a liquid crystal display (LCD), dot matrix display, light emitting diode (LED) display, microLED, organic light-emitting diode (OLED) display, e-ink, or similar monochrome or color display capable of outputting visible information to a user of computing device 102.

UID 104 of computing device 102 may include a presence-sensitive display that may receive tactile input from a user of computing device 102. UID 104 may receive indications of the tactile input by detecting one or more gestures from a user of computing device 102 (e.g., the user touching or pointing to one or more locations of UID 104 with a finger or a stylus pen). UID 104 may present output to a user, for instance at a presence-sensitive display. UID 104 may present the output as a graphical user interface (e.g., user interface 140), which may be associated with functionality provided by computing device 102. For example, UID 104 may present various user interfaces of components of a computing platform, operating system, applications, or services executing at or accessible by computing device 102 (e.g., an electronic message application, an Internet browser application, a mobile operating system, etc.). A user may interact with a respective user interface to cause computing device 102 to perform operations relating to a function.

Computing device 102 also includes haptic device 114 configured to output haptic signals to provide haptic feedback to a user of computing device 102. A haptic signal is a controlled vibration having one or more vibration frequencies and one or more vibration intensities that is a result of forces, vibrations, and/or motions applied by one or more haptic actuators of haptic device 114.

Haptic device 114 may include the one or more haptic actuators, such as linear resonant actuators, eccentric rotating mass vibration motors, piezoelectric transducers, electromechanical devices, and/or other vibrotactile actuators, and drive electronics coupled to the one or more haptic actuators. The drive electronics may cause the one or more haptic actuators to output a haptic signal that, when haptic device 114 is rigidly coupled to the enclosure 108 of computing device 102, induces a vibratory response into at least a portion of the computing device 102.

Computing device 102 also includes motion sensor 106. Motion sensor 106 is an input component that obtains movement information of computing device 102, such as information regarding the tilt, shake, rotation, and/or swing of computing device 102. For example, motion sensor 106 may include a gyroscope, a magnetometer, and/or one or more accelerometers, such as one or more multi-axis accelerometers, and the like. Motion sensor 106, in some examples, is referred to as an inertial measurement unit (IMU).

Computing device 102 may drive haptic device 114 to output haptic signals to alert the user of computing device 102 to the occurrence of events at computing device 102. For example, computing device 102 may drive haptic device 114 to output a haptic signal in response to computing device 102 receiving a phone call or a text message, in response to a payment transaction being accepted or declined, in response to the occurrence of an alarm or a reminder, and the like. Computing device 102 may, in response to determining that an event has occurred, drive haptic device 114 to output a haptic signal to alert the user of computing device 102 to the occurrence of the event.

In some examples, the physical enclosure 108 of computing device 102 may include non-uniform surfaces that may cause computing device 102 to have a poor mechanical connection between computing device 102 and the surrounding environment. In the example where computing device 102 is a mobile computing device, such as a smart phone, the physical enclosure 108 of computing device 102 may include a camera bump 120 that protrudes from back surface 130 of the physical enclosure 108 of computing device 102, which may prevent computing device 102 to be laid flat on back surface 130 against hard surface 150, such as the surface of a table made of a hard material such as wood, steel, glass, or plastic. Computing device 102 may have camera bump 102 in order to accommodate the camera hardware (e.g., image sensors, lens, mirrors, etc.) of computing device 102 while reducing the thickness of the other portions of physical enclosure 108 of computing device 102.

Instead, when computing device 102 is placed on hard surface 150, camera bump 120 may cause computing device 102 to be positioned such that computing device 102 may only contact hard surface 150 at contact points 140A and 140B of computing device 102, which are narrow and unbalanced contact surfaces that provide a weak mechanical connection to hard surface 150. Thus, when computing device 102 vibrates, such as when haptic device 114 of computing device 102 outputs a haptic signal that causes computing device 102 to vibrate, the force of such vibrations may be focused through the unstable contact surfaces of contact points 140A and 140B, which may cause hard surface 150 to, in effect, push back against contact points 140A and 140B, thereby causing computing device 102 to physically bounce (i.e., rattle) against hard surface 150 to create a harsh unpleasant noise.

An environment that causes computing device 102 to, when outputting a haptic signal, rattle against one or more surfaces to create a harsh unpleasant noise and/or produce enough vibrations to cause computing device 102 to physically bounce against a hard surface, such as hard surface 150, may be referred to as an adverse haptic environment. For example, an adverse haptic environment may be an environment in which computing device 102 is placed against a hard surface, such as a surface made of wood, steel, glass, or plastic having at least a specified material hardness. Conversely, an environment that does not cause computing device 102 to create a harsh unpleasant noise may be referred to as a non-adverse haptic environment. For example, if computing device 102 is disposed on a soft surface, such as a cushion or a pillow, such a soft surface may absorb much of the energy produced by computing device 102 as a result of outputting a haptic signal, thereby preventing computing device 102 from producing any harsh unpleasant noise as a result of outputting a haptic signal.

A harsh unpleasant noise may, in some examples, be noise that is caused by computing device 102 rattling against a hard surface as a result of computing device 102 outputting a haptic signal. For example, a harsh unpleasant noise may be noise (e.g., one or more sounds) caused by interference from the surrounding environment (e.g., a hard surface) pushing against computing device 102 that is much louder than the audio volume caused solely by vibrations of computing device 102 resulting from outputting a haptic signal, such as two or more times greater than the sound intensity of the noise produced by computing device 102 outputting the haptic signal.

In some examples, to prevent computing device 102 from producing any harsh unpleasant noise as a result of outputting a haptic signal or to reduce the noise produced by computing device 102, computing device 102 may limit the vibration intensity of every haptic signal that is outputted by haptic device 114 and/or reduce, if not eliminate. vibration frequencies that are likely to resonate from haptic signals outputted by haptic device 114. While haptic signals that have such limited vibration intensities and/or vibration frequencies may reduce the strength of the resulting vibrations of computing devices 102 and therefore prevent preventing computing device 102 from producing any harsh unpleasant noise as a result of outputting a haptic signal, such haptic signals may also reduce the noticeability of the haptic signal being outputted by haptic device 114. That is, haptic signals that have such limited vibration intensities and/or vibration frequencies may produce vibrations of computing device 102 that may be too weak to be noticed by the users of computing device 102 when computing device 102 is in a non-adverse haptic environment.

In accordance with aspects of this disclosure, when computing device 102 determines to output a haptic signal, such as a haptic signal having a vibration intensity that is strong enough to cause computing device 102, when in an adverse haptic environment, to rattle against one or more hard surfaces and produce a harsh unpleasant rattle sound, computing device 102 may determine whether computing device 102 is in an adverse haptic environment. If computing device 102 determines that computing device 102 is in a non-adverse haptic environment, haptic device 114 may output the haptic signal. If computing device 102 determines that computing device is in an adverse haptic environment, haptic device 114 may output an alternative haptic signal in place of the haptic signal, where the alternative haptic signal may have one or more characteristics, such as a reduced vibration intensity compared with the haptic signal, that may make it less likely that computing device 102 may rattle against one or more hard surfaces to produce a harsh unpleasant rattle sound as a result of outputting the alternative haptic signal.

To determine whether computing device 102 is in an adverse haptic environment, haptic device 114 may output a precursor haptic signal. The precursor haptic signal may have a very low vibration intensity, and haptic device 114 may output the precursor haptic signal for a very short period of time, such that the precursor haptic signal may be barely perceptible, if at all, to the user of computing device 102.

As haptic device 114 outputs the precursor haptic signal, computing device 102 may use motion sensor 106 to measure movement of computing device 102 to determine whether computing device 102 is in an adverse haptic environment. When motion sensor 106 and haptic device 114 are rigidly coupled to the same housing, such as when motion sensor 106 and haptic device 114 are in computing device 102, motion sensor 106 may be able to sense movement of the actuator in haptic device 114 when haptic device 114 is being driven to output a haptic signal, such as the precursor haptic signal. More specifically, motion sensor 106 may be able to sense movement that is a combination of the actuator movement and interference from the surrounding environment. Such interference may be caused by physical movement of computing device 102 itself, such as movement of computing device 102 that is in a pocket while the user of computing device 102 is walking.

Such interference may also be caused by reflections or consequential forces caused by the actuator of haptic device 114 and/or caused by the surrounding environment. For example, the forces of the actuator of haptic device 114 against hard surface 150 may cause hard surface 150 to, in effect, push back against computing device 102, and the weak mechanical connections provided by contact points 140A and 140B may cause computing device 102 to physically bounce on or even off hard surface 150. Motion sensor 106 may capture such forces. Conversely, a soft surface (e.g., a cushion or a pillow) may absorb much of the energy produced by computing device 102 outputting a haptic signal and motion sensor 106 may observe a diminished or “filtered” signal.

As such, motion sensor 106 of computing device 102 may measure the motion of computing device 102 while haptic device 114 outputs the precursor haptic signal to generate a motion signal associated with outputting the precursor haptic signal. That is, as haptic device 114 outputs the precursor signal, motion sensor 106 may measure the motion of computing device 102 to generate the motion signal.

Computing device 102 may determine, based at least in part on the motion signal associated with outputting the precursor haptic signal, whether computing device 102 is in an adverse haptic environment. For example, computing device 102 may compare the motion signal associated with outputting the precursor haptic signal with a motion signal produced in a non-adverse haptic environment to determine whether the motion signal associated with outputting the precursor haptic signal is indicative of computing device 102 is in an adverse haptic environment.

Computing device 102 may, in response to determining that the computing device is not in an adverse haptic environment, drive haptic device 114 to output a haptic signal that may have one or more characteristics, such as a high vibration intensity, that may cause computing device 102, when in an adverse haptic environment, to produce a harsh unpleasant rattle sound. Conversely, computing device 102 may, in response to determining that the computing device is in an adverse haptic environment, drive haptic device 114 to output an alternative haptic signal instead of the haptic signal. Such an alternative haptic signal may be a haptic signal having one or more characteristics, such as a relatively low vibration intensity, that, when outputted by haptic device 114, may not cause computing device 102, when in an adverse haptic environment, to rattle against one or more hard surfaces to produce a harsh unpleasant rattle sound.

While described with respect to motion sensor 106, one or more other sensors of computing device 102 may perform or assist in detecting whether computing device 102 is in an adverse haptic environment. In some examples, computing device 102 may use one or more microphones alone or in combination with motion sensor 106 and/or other sensors of computing device 102 to determine whether computing device 102 is in an adverse haptic environment.

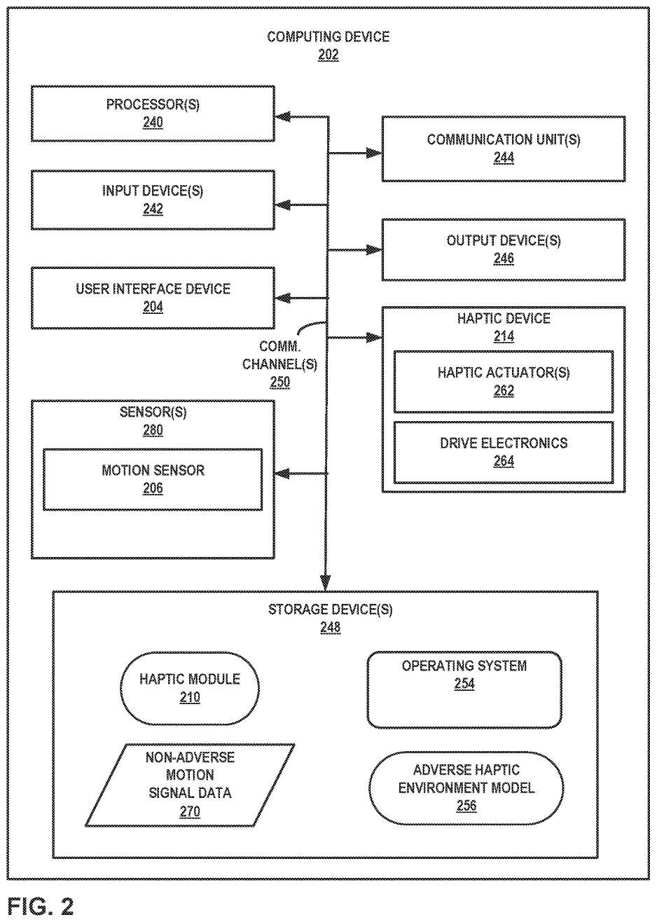

FIG. 2 is a block diagram illustrating an example computing device 202, in accordance with one or more aspects of the present disclosure. Computing device 202 of FIG. 2 is an example of computing device 102 of FIG. 1. Computing device 202 is only one particular example of computing device 102 of FIG. 1, and many other examples of computing device 102 may be used in other instances. In the example of FIG. 2, computing device 202 may be a mobile computing device (e.g., a smartphone), or any other computing device. Computing device 202 of FIG. 2 may include a subset of the components included in example computing device 202 or may include additional components not shown in FIG. 2.

As shown in the example of FIG. 2, computing device 202 includes user interface device 204 (“UID 204”), one or more processors 240, one or more input devices 242, one or more communication units 244, one or more output devices 246, one or more storage devices 248, one or more sensors 280, and haptic device 214. Storage devices 248 of computing device 202 also include non-adverse motion signal data 270, operating system 254, adverse haptic environment model 256, and haptic module 210.

Communication channels 250 may interconnect each of the components 240, 242, 244, 246, 248, 204, 280, and 214 for inter-component communications (physically, communicatively, and/or operatively). In some examples, communication channels 250 may include a system bus, a network connection, an inter-process communication data structure, or any other method for communicating data.

One or more input devices 242 of computing device 202 may be configured to receive input. Examples of input are tactile, audio, and video input. Input devices 242 of computing device 202, in one example, includes a presence-sensitive display, touch-sensitive screen, mouse, keyboard, voice responsive system, video camera, microphone or any other type of device for detecting input from a human or machine.

One or more output devices 246 of computing device 202 may be configured to generate output. Examples of output are tactile, audio, and video output. Output devices 246 of computing device 202, in one example, includes a presence-sensitive organic light emitting diode (OLED) display, sound card, video graphics adapter card, speaker, monitor, a presence-sensitive liquid crystal display (LCD), or any other type of device for generating output to a human or machine.

One or more communication units 244 of computing device 202 may be configured to communicate with external devices via one or more wired and/or wireless networks by transmitting and/or receiving network signals on the one or more networks. Examples of communication unit 244 include a network interface card (e.g. such as an Ethernet card), an optical transceiver, a radio frequency transceiver, a GPS receiver, or any other type of device that can send and/or receive information. Other examples of communication units 44 may include short wave radios, cellular data radios, wireless network radios, as well as universal serial bus (USB) controllers.

In some examples, UID 204 of computing device 202 may include functionality of input devices 242 and/or output devices 246. In the example of FIG. 2, UID 204 may be or may include a presence-sensitive input device. In some examples, a presence sensitive input device may detect an object at and/or near a screen. As one example range, a presence-sensitive input device may detect an object, such as a finger or stylus that is within 2 inches or less of the screen. The presence-sensitive input device may determine a location (e.g., an (x, y) coordinate) of a screen at which the object was detected. In another example range, a presence-sensitive input device may detect an object six inches or less from the screen and other ranges are also possible. The presence-sensitive input device may determine the location of the screen selected by a user's finger using capacitive, inductive, and/or optical recognition techniques. In some examples, a presence sensitive input device also provides output to a user using tactile, audio, or video stimuli as described with respect to output device 246, e.g., at a display. In the example of FIG. 2, UID 204 may present a user interface.

While illustrated as an internal component of computing device 202, UID 204 also represents an external component that shares a data path with computing device 202 for transmitting and/or receiving input and output. For instance, in one example, UID 204 represents a built-in component of computing device 202 located within and physically connected to the external packaging of computing device 202 (e.g., a screen on a mobile phone). In another example, UID 204 represents an external component of computing device 202 located outside and physically separated from the packaging of computing device 202 (e.g., a monitor, a projector, etc. that shares a wired and/or wireless data path with a tablet computer).

One or more sensors 280 of computing device 202 may include any input component configured to obtain environmental information about the circumstances surrounding computing device 202 In some examples, a sensor may be an input component that obtains physical position, movement, and/or location information of computing device 202. For instance, one or more sensors 280 may include a location sensor (e.g., Global Positioning System sensors), a temperature sensor, a pressure sensor (e.g., a barometer), an ambient light sensors, a microphone, a camera, an infrared proximity sensor, a hygrometer, a heart rate sensor, a glucose sensor, a hygrometer sensor, an olfactory sensor, a compass sensor, a step counter sensor, to name a few other non-limiting examples.

In some examples, one or more sensors 280 include motion sensor 206, which is an example of motion sensor 106 of FIG. 1. Motion sensor 206 may include one or more multi-axial accelerometers (e.g., a three-axis accelerometer, a six-axis accelerometer, etc.), one or more gyroscopes, one or more magnetometers, and/or any other sensor configured to obtain motion information regarding computing device 202.

Haptic device 214 of computing device 202 is an example of haptic device 114 of FIG. 1 and may be configured to output haptic signals, such as in the form of vibrations and/or other forms of tactile haptic feedback. Haptic device 214 outputting a haptic signal may cause computing device 202 to vibrate, such that the vibrations of computing device 202 caused by haptic device 214 outputting the haptic signal may be both tactically and audibly apparent to the user of computing device 202. For example, a haptic signal outputted by haptic device 214 can be felt by users of computing device 202 that hold computing device 202 and/or that touch an external surface of the enclosure of computing device 202 and may also be heard by a user of computing device 202. Haptic device 214 includes one or more haptic actuators 262 and drive electronics 264.

One or more haptic actuators 262 may include one or more linear resonant actuators, one or more eccentric rotating mass vibration motors, one or more piezoelectric transducers, one or more electromechanical devices, and/or other vibrotactile actuators that may create motion (e.g., vibrate) to impart information to the user of computing device 202 through the user's sense of touch. For example, a linear resonant actuator may vibrate by moving a mass in a reciprocal manner by means of a magnetic voice coil.

In some examples, one or more haptic actuators 262 may be an x-axis linear resonant actuator where the mass moves along a long axis of the actuator. In the example where computing device 202 is a smart phone, the mass in an x-axis linear resonant actuator may move along an axis that is parallel to the plane of the display of the smart phone. In some examples, one or more haptic actuators 262 may be a z-axis linear resonant actuator where the mass moves along a short axis of the actuator. In the example where computing device 202 is a smart phone, the mass in a z-axis linear resonant actuator may move along an axis that is perpendicular to the plane of the display of the smart phone. A z-axis linear resonant actuator may typically be smaller than an x-axis linear resonant actuator, but may be more prone to causing a disruptive rattling effect when outputting a haptic signal as the z-axis linear resonant actuator may typically apply force in a direction that is perpendicular to a surface on which computing device 202 is placed, thereby pushing computing device 202 away from that surface and potentially creating resonance at the contact points of computing device 202 and the surface.

Drive electronics 264 may be circuitry coupled to one or more haptic actuators 262 to cause one or more haptic actuators 262 to vibrate (e.g., output a haptic signal) to induce a selected vibratory response into at least a portion of the computing device 202, thereby providing a tactile sensation and/or an audible sensation to a user of computing, device 202. Drive electronics 264 may, in response to haptic device 214 receiving an indication of a drive signal (e.g., from one or more processors 240), drive one or more haptic actuators 262 to vibrate to output a haptic signal. That is, drive electronics 264 may drive one or more haptic actuators 262 at the frequency and at the vibration intensities indicated or otherwise associated with the drive signal to output a haptic signal.

One or more storage devices 248 within computing device 202 may store information for processing during operation of computing device 202. In some examples, storage device 248 is a temporary memory, meaning that a primary purpose of storage device 248 is not long-term storage. Storage devices 248 on computing device 202 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage devices 248, in some examples, also include one or more computer-readable storage media. Storage devices 248 may be configured to store larger amounts of information than volatile memory. Storage devices 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage devices 248 may store program instructions and/or information (e.g., data) associated with haptic module 210, non-adverse motion signal data 270, adverse haptic environment model 256, and operating system 254.

One or more processors 240 may implement functionality and/or execute instructions within computing device 202. For example, processors 240 on computing device 202 may receive and execute instructions stored by storage devices 248 that execute the functionality of haptic module 210, adverse haptic environment model 256, and operating system 254. These instructions executed by processors 240 may, for example, cause haptic device 214 of computing device 202 to output a haptic signal.

Haptic module 210 and operating system 254 is described below executing at one or more processors 240. It should be understood that one or more processors 240 are configured to execute haptic module and operating system 254 to perform the functionality of haptic module 210 and operating system 254 described below. That is, one or more processors 240 are configured to execute the instructions of haptic module 210 and operating system 254 to perform the functionality of haptic module 210 and operating system 254 described below.

Operating system 254 may execute at one or more processors 240 to determine to output a haptic signal in response to the occurrence of an event. In some examples, operating system 254 may, for a plurality of types of events, associate each type of event with a respective haptic signal. For example, operating system 254 may associate a haptic signal with receiving a call (e.g., receiving a voice call and/or a video call) and may associate a haptic signal with receiving a notification. Thus, operating system 254 may, in response to computing device 202 receiving a voice call or a video call, determine to output a haptic signal associated with receiving a call. Similarly, operating system 254 may, in response to computing device 202 receiving a notification, determine to output a haptic signal associated with receiving a notification.

In some examples, operating system 254 may execute at one or more processors 240 to determine to output a haptic signal to produce haptic feedback that can be felt by a user that interacts with a presence-sensitive input screen of UID 204. For example, operating system 254 may execute at one or more processors 240 to, in response to UID 204 receiving user input to select a button in a user interface displayed at UID 204, determine to output a haptic signal that produces a haptic effect associated with the button being selected.

Different haptic signals may have different characteristics, such as having different vibration frequencies and/or vibration intensities. For example, a haptic signal associated with receiving a call may have a different vibration frequency and/or vibration intensity compared with a haptic signal associated with receiving a notification. In some examples, operating system 254 may associate different haptic signals with different contacts of the user of computing device 202. As such, a haptic signal associated with receiving a call from a contact of the user may have a different vibration frequency and/or vibration intensity compared with a haptic signal associated with a different contact of the user.

Operating system 254 may, in response to determining to output a haptic signal, such as a haptic signal associated with an occurrence of an event, determine whether computing device 202 is in an adverse haptic environment. By determining whether computing device 202 is in an adverse haptic environment, operating system 254 may determine whether to output the haptic signal or to output an alternative haptic signal.

In some examples, operating system 254 may, in response to determining to output a haptic signal, refrain from determining whether computing device 202 is in an adverse haptic environment. Operating system 254 may refrain from determining whether computing device 202 is in an adverse haptic environment if the characteristics of computing device 202 indicates that it is unlikely that computing device 202 is in an adverse haptic environment. For example, if operating system 254 determines, such as based on sensor data generated by one or more sensors 280, that computing device 202 is moving, operating system 254 may determine that it is unlikely that computing device 202 is in an adverse haptic environment. In another example, if operating system 254 determines, such as based on sensor data generated by one or more sensors 280 or based on user interactions received by UID 204, that a user is actively interacting with computing device 202, operating system 254 may determine that it is unlikely that computing device 202 is in an adverse haptic environment.

Operating system 254 may, in response to determining to output a haptic signal, determine whether computing device 202 is in an adverse haptic environment only if one or more characteristics of computing device 202 indicate that it is likely that computing device 202 is in an adverse haptic environment. For example, if operating system 254 determines, such as based on sensor data generated by one or more sensors 280, that computing device 202 is not moving and/or has not moved for a specified period of time (e.g., for the last minute, for the last two minutes, etc.), operating system 254 may determine that it is likely that computing device 202 is in an adverse haptic environment. In another example, if operating system 254 determines, such as based on the screen of computing device 202 being turned off or based on the lack of user interactions received by UID 204 for a specified period of time (e.g., for the last minute), that a user is not actively interacting with computing device 202, operating system 254 may determine that it is likely that computing device 202 is in an adverse haptic environment.

In some examples, operating system 254 may, in response to determining to output a haptic signal, determine whether computing device 202 is in an adverse haptic environment only if the haptic signal that operating system 254 has determined to output has a vibration intensity that is greater than a vibration intensity threshold and/or is of a duration that is longer than a duration threshold. That is, operating system 254 may determine whether computing device 202 is in an adverse haptic environment only if the haptic signal is likely to produce a harsh rattling effect when outputted by haptic device 214. As such, operating system 254 may execute at one or more processors 240 to determine whether the haptic signal has a duration that is greater than a duration threshold and whether the vibration intensity of the haptic signal is greater than a vibration intensity threshold. If operating system 254 determines that the haptic signal has a duration that is greater than a duration threshold and whether the vibration intensity of the haptic signal is greater than a vibration intensity threshold, operating system 254 may execute at one or more processors 240 to determine whether computing device 202 is in an adverse haptic environment.

Operating system 254 may, in some instances, refrain from determining whether computing device 202 is in an adverse haptic environment in latency-sensitive situations. For example, if haptic device 214 outputs haptic signals to produce haptic feedback to a user as the user interacts with a virtual keyboard displayed at UID 204 to input text, any lag or delay in producing such haptic feedback may decrease the user experience of inputting text using the virtual keyboard. In such a latency-sensitive situation, operating system 254 may refrain from determining whether computing device 202 is in an adverse haptic environment prior to driving haptic device 214 to output haptic signals to produce haptic feedback to the user.

In accordance with techniques of this disclosure, to determine whether computing device 202 is in an adverse haptic environment, haptic module 210 may execute at one or more processors 240 to determine whether computing device 202 is in an adverse haptic environment. As part of determining whether computing device 202 is in an adverse haptic environment, haptic module 210 may execute at one or more processors 240 to drive haptic device 214 to output a precursor haptic signal. That is, haptic module 210 may execute at one or more processors 240 to send, via one or more communication channels 250, a signal to drive electronics 264. The signal may specify one or more characteristics of the precursor haptic signal, such as the frequency and/or the vibration intensities of the precursor signal. Drive electronics 264 may, in response to receiving the signal, drive one or more haptic actuators 262 to vibrate to output a precursor haptic signal at the frequency and/or at one or more vibration intensities indicated or otherwise associated with the signal to output the precursor haptic signal.

The precursor haptic signal may be a haptic signal outputted for a short duration that is barely perceivable to the user of computing device 202 but is strong enough to elicit a rattling response by computing device 202. The precursor haptic signal may have an extremely low amplitude (i.e., vibration intensity), that is outputted by haptic device 214 for a short duration. For example, the amplitude of the precursor haptic signal may have an amplitude that is about 5-10% of the amplitude of a haptic signal that is outputted for a notification (e.g., a haptic signal associated with an event type), and haptic device 214 may be configured to output the precursor haptic signal for less than a second, less than half a second, less than 100 milliseconds, less than 50 milliseconds, less than 20 milliseconds, and the like.

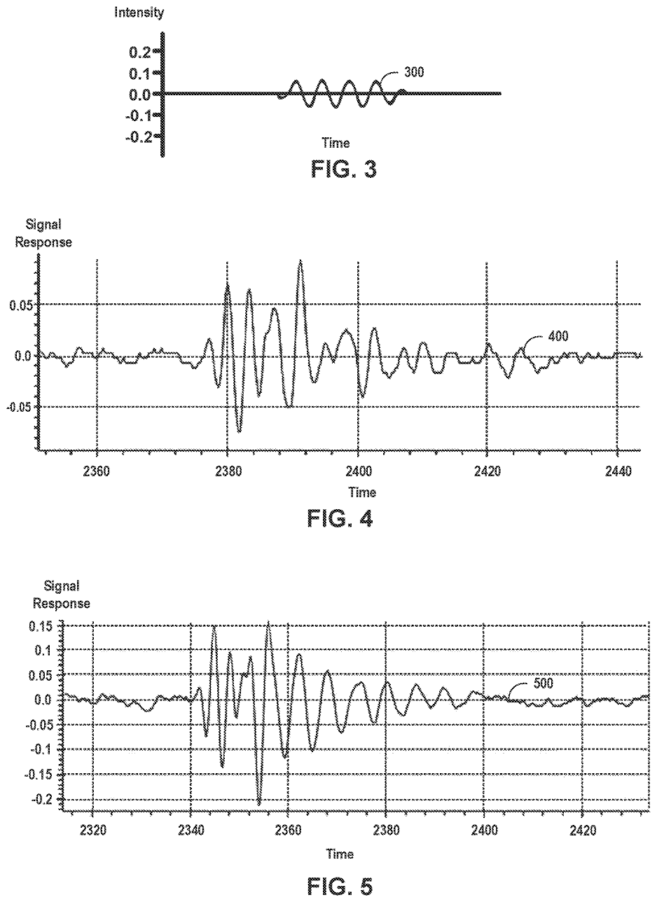

FIG. 3 is a conceptual diagram illustrating an example precursor haptic signal outputted by an example haptic device. For purposes of illustration only, FIG. 3 is described within the context of computing device 202 of FIG. 2, but may be implemented with respect to any type of computing device listed in this disclosure.

As described above, haptic device 214 of computing device 202 may output a precursor haptic signal in a manner that elicits a rattling response that can be measured by a motion sensor of computing device 202 but that cannot be or almost cannot be perceived (audibly or tactically) by the user of the computing device. As shown in FIG. 3, one example of a precursor haptic signal 300 may be an extremely low amplitude 300 Hertz (Hz) Sine wave chirp signal with a duration of about 18 milliseconds (ms). The combination of the low amplitude, frequency ramp, and short duration may make the precursor haptic signal 300 almost undetectable audibly and/or tactically for the user of computing device 202 while still being able to elicit a rattling response by computing device 202.

Motion sensor 206 may be configured to, while haptic device 214 outputs at least a portion of the precursor haptic signal, sense the motion of computing device 202. That is, motion sensor 206 may be able to sense motion that is caused by the vibrations of the precursor haptic signal being outputted by haptic device 214. Such motion caused by the vibrations of the precursor haptic signal being outputted by haptic device 214 may include the force response to the precursor haptic signal being outputted by haptic device 214 and may also include motion caused by environmental interference such as reflections and resonance as a result of haptic device 214 outputting the precursor haptic signal.

In some examples, motion sensor 206 may be configured to sense the motion of computing device 202 in one or more directions. For example, if motion sensor 206 includes a multi-axis, motion sensor 206 may be configured to sense the motion of computing device 202 along at least one of the multiple axes of the accelerometer. In some examples, motion sensor 206 may sense the motion at least along an axis of motion sensor 206 that corresponds to an axis of a linear haptic actuator (e.g., of one or more haptic actuators 262) of haptic device 214 along which a mass of haptic device 214 moves to output the precursor haptic signal. That is, motion sensor 206 may be configured to sense at least the motion along the axis parallel to the primary axis of movement of the one or more haptic actuators 262.

Haptic module 210 may execute at one or more processors 240 to determine, based at least in part on the motion of computing device 202 sensed by motion sensor 206, a motion signal associated with outputting the precursor haptic signal. Specifically, haptic module 210 may execute at one or more processors 240 to determine a motion signal that corresponds to the motion sensed by motion sensor 206 along the axis parallel to the primary axis of movement of the one or more haptic actuators 262. Thus, if one or more haptic actuators 262 is an x-axis linear resonant actuator, then haptic module 210 may determine a motion signal that corresponds to the motion sensed by motion sensor 206 along the x-axis.

FIG. 4 is a conceptual diagram that illustrates an example motion sensor response when an example haptic device outputs an example precursor haptic signal in a non-adverse haptic environment. For purposes of illustration only, FIG. 4 is described within the context of computing device 202 of FIG. 2, but may be implemented with respect to any type of computing device listed in this disclosure.

As shown in FIG. 4, when haptic device 214 of computing device 202 outputs a precursor haptic signal, such as precursor haptic signal 300 shown in FIG. 3, in a non-adverse haptic environment, motion sensor 206 of computing device 202 may sense motion caused by haptic device 214 outputting a precursor haptic signal, and haptic module 210 may execute at one or more processors 240 to generate motion signal 400 that corresponds to the motion sensed by motion sensor 206 caused by haptic device 214 outputting the precursor haptic signal. Because motion signal 400 corresponds to motion caused by haptic device 214 outputting the precursor haptic signal in a non-adverse haptic environment, motion signal 400 may, in some examples, be referred to as a non-adverse motion signal.

While motion sensor 206 may be configured to sense motion in multiple axes, motion signal 400 corresponds to the motion sensed by motion sensor 206 along the axis parallel to the primary axis of movement of the one or more haptic actuators 262. As such, motion signal 400 may be the acceleration measured over time in an axis of an accelerometer that is parallel to the primary axis of movement of the one or more haptic actuators 262. If one or more haptic actuators 262 are a z-axis linear resonant actuator, then motion signal 400 may be a motion signal that corresponds to motion in the z-axis sensed by motion sensor 206.

Samples of motion signal 400 before 2368 and after 2420 are the baseline noise for motion sensor 206. The intermediate samples of motion signal 400 (the portion of motion signal 400 between 2368 and 2420) include four peaks that represent the force response to the precursor haptic signal being outputted by haptic device 214, and may also represent environmental interference such as reflections and resonance.

FIG. 5 is a conceptual diagram that illustrates an example motion sensor response when an example haptic device outputs an example precursor haptic signal in an adverse haptic environment. For purposes of illustration only, FIG. 5 is described within the context of computing device 202 of FIG. 2, but may be implemented with respect to any type of computing device listed in this disclosure.

As shown in FIG. 5, when haptic device 214 outputs a precursor signal, such as precursor haptic signal 300 shown in FIG. 3, in an adverse haptic environment, motion sensor 206 may sense the motion caused by haptic device 214 outputting a precursor haptic signal, and haptic module 210 may execute at one or more processors 240 to generate a motion signal 500 to correspond to the motion sensed by motion sensor 206. Because motion signal 500 corresponds to motion caused by haptic device 214 outputting the precursor haptic signal in an adverse haptic environment, motion signal 500 may, in some examples, be referred to as an adverse motion signal.

While motion sensor 206 may be configured to sense motion in multiple axes, motion signal 500 corresponds to the motion sensed by motion sensor 206 along the axis parallel to the primary axis of movement of the one or more haptic actuators 262. As such, motion signal 500 may be the acceleration measured over time in an axis of an accelerometer that is parallel to the primary axis of movement of the one or more haptic actuators 262. If one or more haptic actuators 262 are a z-axis linear resonant actuator, then motion signal 500 may be a motion signal that corresponds to motion in the z-axis sensed by motion sensor 206.

As can be seen, motion signal 500 has a greater average amplitude and a greater peak amplitude compared with motion signal 400. In addition, motion signal 500 may also have a longer resonating output (e.g., about 10 cycles compared with 4 cycles) compared with motion signal 400. To better distinguish between a non-adverse motion signal (e.g., motion signal 400) and an adverse motion signal (e.g., motion signal 500), non-adverse motion signals and adverse motion signals can be transformed to extract data that may be more conducive to algorithmic discrimination between adverse and non-adverse haptic environments. Specifically, non-adverse motion signals and adverse motion signals can be better distinguished in a frequency domain, compared with the time domain examples shown in FIGS. 4 and 5.

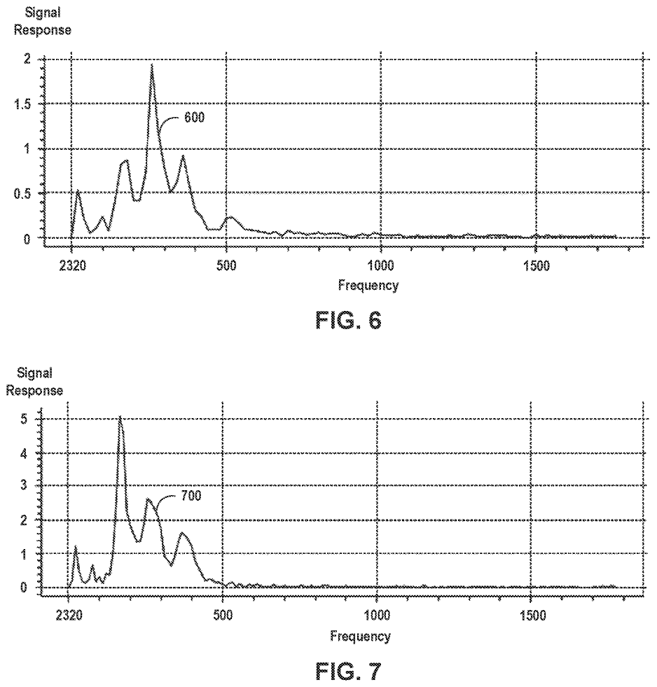

FIG. 6 is a conceptual diagram that illustrates the example motion signal 400 of FIG. 4 transformed from the time domain into the frequency domain. For purposes of illustration only, FIG. 6 is described within the context of computing device 202 of FIG. 2, but may be implemented with respect to any type of computing device listed in this disclosure.

As shown in FIG. 6, motion signal 600 is motion signal 400 of FIG. 4 transformed (e.g., via FFT) from the time domain to the frequency domain. The peak of motion signal 600 is at 260 Hz, which differs from the 300 Hz precursor haptic signal 300 shown in FIG. 3 due to transmission interference between motion sensor 206 and one or more haptic actuators 262 of haptic device 214.

FIG. 7 is a conceptual diagram that illustrates the example motion signal 500 of FIG. 5 transformed from the time domain into the frequency domain. For purposes of illustration only, FIG. 7 is described within the context of computing device 202 of FIG. 2.

As shown in FIG. 7, motion signal 700 is motion signal 500 of FIG. 5 transformed (e.g., via FFT) from the time domain to the frequency domain. The peak of motion signal 700 is at about 160 Hz, which differs from the peak of motion signal 600 at 260 Hz. The peak of motion signal 700 is of a much greater magnitude than the peak of motion signal 600. The peak of motion signal 600 is also observable in motion signal 700 at 260 Hz.

Haptic module 210 may execute at one or more processors 240 to determine, based at least in part on the motion signal associated with outputting the precursor haptic signal, whether computing device 202 is in an adverse haptic environment. Specifically, haptic module 210 may execute at one or more processors 240 to compare the motion signal associated with outputting the precursor haptic signal with a motion signal that corresponds to a non-adverse haptic environment.

A motion signal that corresponds to a non-adverse haptic environment may be a motion signal that corresponds to motion caused by a haptic device (e.g., haptic device 214) outputting the precursor haptic signal in a non-adverse haptic environment. An example of such a motion signal is motion signal 400 illustrated in FIG. 4 and motion signal 600 illustrated in FIG. 6. One or more storage devices 248 may include non-adverse motion signal data 270, which is data indicative of a non-adverse motion signal (i.e., a motion signal that corresponds to a non-adverse haptic environment), an example of which is motion signal 400 shown in FIG. 4 and/or motion signal 600 shown in FIG. 6. In some examples, non-adverse motion signal data 270 may be installed on one or more storage devices 248 during manufacturing of computing device 248 or as part of operating system 254. In some examples, one or more processors 240 may be configured to determine non-adverse motion signal data during operation of computing device 202.

Haptic module 210 may therefore execute at one or more processors 240 to compare the motion signal associated with outputting the precursor signal with a non-adverse motion signal indicated by non-adverse motion signal data 270. As described above with respect to FIGS. 6 and 7, one or more processors 240 may be able to better algorithmically distinguish between motion signals in adverse and non-adverse haptic environments in a frequency domain. As such, to compare the motion signal associated with outputting the precursor signal with a non-adverse motion signal, haptic module 210 may execute at one or more processors 240 to transform the motion signal associated with outputting the precursor signal from a time domain into a frequency domain. For example, haptic module 210 may execute at one or more processors 240 to perform a Fourier transform, such as a fast Fourier transform (FFT), on the motion signal associated with outputting the precursor signal in a time domain to transform the motion signal associated with outputting the precursor signal into a frequency domain.

In some examples, the non-adverse motion signal indicated by non-adverse motion signal data 270 may already be in a frequency domain. In examples where the non-adverse motion signal indicated by non-adverse motion signal data 270 is in a time domain, haptic module 210 may execute at one or more processors 240 to transform the non-adverse motion signal indicated by non-adverse motion signal data 270 to a frequency domain, such as by performing a FFT on the non-adverse motion signal indicated by non-adverse motion signal data 270 to transform the non-adverse motion signal from a time domain to a frequency domain.

As illustrated above in FIGS. 6 and 7, an adverse motion signal in a frequency domain (e.g., motion signal 700 shown in FIG. 7) may have a much greater peak amplitude compared with the peak amplitude of a non-adverse motion signal in the frequency domain (e.g., motion signal 600 shown in FIG. 6). Further, the peak amplitude of the adverse motion signal in the frequency domain may occur at a lower harmonic frequency compared with the peak amplitude of the non-adverse motion signal in the frequency domain. Thus, a motion signal associated with outputting a precursor signal may indicate that computing device 202 is in an adverse haptic environment if the peak amplitude of the motion signal is much greater (e.g., two times or more) than the peak amplitude of a non-adverse motion signal and if the peak amplitude of the adverse motion signal in the frequency domain occurs at a lower harmonic frequency compared with the peak amplitude of the non-adverse motion signal in the frequency domain.

As such, in some examples, haptic module 210 may execute at one or more processors 240 to compare the magnitude, in the frequency domain, of the peak amplitude of the motion signal associated with outputting the precursor signal with the magnitude, in the frequency domain, of the peak amplitude of the non-adverse signal. Haptic module 210 may also execute at one or more processors 240 to compare the frequency, in the frequency domain, at which the peak amplitude of the motion signal associated with outputting the precursor signal occurs with the frequency, in the frequency domain, at which the peak amplitude of the non-adverse motion signal occurs.

In some examples, haptic module 210 may execute at one or more processors 240 to determine that computing device 202 is in an adverse haptic environment if the peak amplitude of the motion signal associated with outputting the precursor signal in the frequency domain is greater than the peak amplitude of the non-adverse motion signal in the frequency domain. In some examples, haptic module 210 may execute at one or more processors 240 to determine that the computing device is in an adverse haptic environment if the peak amplitude of the motion signal associated with outputting the precursor signal in the frequency domain is significantly greater, such as at least two times greater, at least 2.5 times greater, and the like, than the peak amplitude of the non-adverse motion signal in the frequency domain.

In some examples, haptic module 210 may execute at one or more processors 240 to determine that computing device 202 is in an adverse haptic environment if the peak amplitude of the motion signal associated with outputting the precursor signal in the frequency domain is greater (e.g., at least two times greater) than the peak amplitude of the non-adverse motion signal in the frequency domain, and if the peak amplitude of the motion signal associated with outputting the precursor signal in the frequency domain occurs at a lower harmonic frequency compared with the peak amplitude of the non-adverse motion signal in the frequency domain. In this way, haptic module 210 may use non-adverse motion data as a template against which the motion signal associated with outputting the precursor signal in the frequency domain can be compared to determine whether the motion signal associated with outputting the precursor signal indicates that computing device 202 is in an adverse haptic environment.

In some examples, one or more processors 240 may be configured to use adverse haptic environment model 256 to compare the motion signal associated with outputting the precursor signal with the non-adverse motion signal to determine whether computing device 202 is in an adverse haptic environment. Adverse haptic environment model 256 may take, as input, the motion signal associated with outputting the precursor signal and the non-adverse motion signal, and may output an indication of whether computing device 202 is in an adverse haptic environment. In some examples, adverse haptic environment model 256 may output one or more probabilities, such as a probability that computing device 202 is in an adverse haptic environment and/or a probability that computing device 202 is in a non-adverse haptic environment. In some examples, adverse haptic environment model 256 may classify computing device 202 as either being in an adverse haptic environment or in a non-adverse haptic environment.

Adverse haptic environment model 256 may be a machine-trained model trained via machine learning to distinguish between motion signals generated by computing devices in adverse haptic environments and motion signals generated by computing devices in non-adverse haptic environments. In some examples, adverse haptic environment model 256 may include one or more of convolutional neural networks, recurrent neural networks, or any other suitable artificial neural network. In some examples, adverse haptic environment model 256 may be a classification tree algorithm trained using decision tree learning.

Adverse haptic environment model 256 may be trained via supervised machine learning. For example, adverse haptic environment model 256 may be trained using training data that include motion signals that are labeled as being in adverse haptic environments and non-adverse haptic environments to generate adverse haptic environment model 256 that may be able to distinguish between a motion signal in in an adverse haptic environment and a motion signal in a non-adverse haptic environment.

Haptic module 210 may execute at one or more processors 240 to, in response to determining that computing device 202 is in an adverse haptic environment, drive haptic device 214 to output an alternative haptic signal instead of the haptic signal. The haptic signal may be a haptic signal that haptic device 214 would have outputted if computing device 102 was in a non-adverse haptic environment. For example, if haptic module 210 determines whether computing device 202 is in an adverse haptic environment in response to computing device 202 receiving a phone call, the haptic signal may have been associated by operating system 254 with an event type of computing device 202 receiving a phone call.

Such a haptic signal may have a vibration pattern, which may be associated with a vibration frequency (i.e., the number of vibrations outputted by haptic device 214 within a specified time period) and a pattern of vibration intensities that specify the intensities of the vibrations outputted by haptic device. The alternative haptic signal that is outputted instead of a haptic signal may have a vibration intensity that is smaller than the vibration intensity of the haptic signal. For example, the alternative haptic signal may have a peak vibration intensity that is smaller than the peak vibration intensity of the haptic signal. In some examples, the alternative haptic signal may also not include one or more resonant frequencies that may cause computing device 202 to produce a harsh rattle in an adverse haptic environment.

In some examples, the alternative haptic signal may have the same vibration pattern as the haptic signal but at reduced vibration intensities. For example, the alternative haptic signal may have the same vibration frequencies as the corresponding haptic signal but at a lower vibration intensity compared to the corresponding haptic signal.

A haptic signal may have an amplitude that corresponds to the vibration intensity of the haptic signal. For example, the amplitude of the alternative haptic signal may correspond to the vibration intensity of the alternative haptic signal, and the amplitude of the haptic signal may correspond to the vibration intensity of the haptic signal. As such, an alternative haptic signal may have an amplitude that is smaller than the amplitude of the haptic signal.

The amplitude of the alternative haptic signal may be a value that reduces the amount of rattling of computing device 202 on a solid surface that is caused by haptic device 214 outputting a haptic signal. For example, the alternative haptic signal may have amplitude that is 50% of the amplitude of the haptic signal. In some examples, the alternative haptic signal may have an amplitude that is between 30% to 70% of the amplitude of the haptic signal. In some examples, the alternative haptic signal may have a peak amplitude that is less than the peak amplitude of the haptic signal, such as 50% of the peak amplitude of the haptic signal, between 30% to 70% of the peak amplitude of the haptic signal, and the like.

When haptic device 214 outputs a haptic signal, the haptic device 214 may generate noise due to vibrations of haptic device 214 as well as due to vibrations of computing device 202 caused by haptic device 214 outputting the haptic signal. Such noise generated as a result of haptic device 214 outputting a haptic signal may be referred to as an audio component of the haptic signal. Because an alternative haptic signal may have an amplitude that is much smaller than the amplitude of the haptic signal, the audio component of the alternative haptic signal may similarly be much smaller than the audio component of the haptic signal. That is, the sound produced by computing device 202 as a result of haptic device 214 outputting an alternative haptic signal may be significantly quieter than the sound produced by computing device 202 as a result of haptic device 214 outputting the haptic signal. The audio component of the alternative haptic signal being much smaller than the audio component of the haptic signal may cause some users of computing device 202 to fail to notice that computing device 202 is attempting to alert the user to the occurrence of a particular event by outputting the alternative haptic signal.

As such, in some examples, computing device 202 may, along with outputting an alternative haptic signal, also output audio, via one or more audio output devices (e.g., speakers) of computing device 202, that is more audible (e.g., at a higher volume) than the audio component of the alternative haptic signal. In some examples, computing device 202 may output such audio even when audio alerts (e.g., ringtones) are muted, such as when computing device 202 is set to a silent mode or a vibration-only mode.

For example, one or more processors 240 may be configured to, while driving haptic device 214 to output an alternate haptic signal, also output, via one or more audio output devices of one or more output devices 246, an audio signal that corresponds to the audio component of a haptic signal having a greater vibration intensity than the alternate haptic signal. For example, one or more processors 240 may be configured to output, via one or more audio devices, an audio signal that corresponds to the audio produced by a computing device as a result of outputting a haptic signal in a non-adverse haptic environment.

Such an audio signal may be pre-recorded and stored in one or more storage devices 248 or may be generated by one or more processors 240. If such an audio signal is generated by one or more processors 240, operating system 254 may enable user customization of the audio signal, such as customizing the loudness of the audio signal or changing any other characteristics of the audio signal.

In some examples, one or more processors 240 may be configured to synchronize the playback of the audio signal with the outputting of the alternative haptic signal so that the amplitude of the audio signal is correlated with the alternative haptic signal. Synchronizing the playback of the audio signal with the outputting of the alternative haptic signal may ensure that any audible sound produced by haptic device 214 as a result of outputting the alternative haptic signal does not conflict with the audio signal being outputted via one or more output devices 246.

In some examples, if one or more output devices 246 includes a plurality of audio output devices, such as a plurality of speakers, positioned in different areas of computing device 202, one or more processors 240 may be configured to select a subset (i.e., fewer than all) of the plurality of speakers for outputting the audio signal as haptic device 214 outputs the alternative haptic signal. In some examples, one or more processors 240 may be configured to select, out of a plurality of audio output devices, one or more audio devices that are closest in distance to haptic device 214 for outputting the audio signal as haptic device 214 outputs the alternative haptic signal.

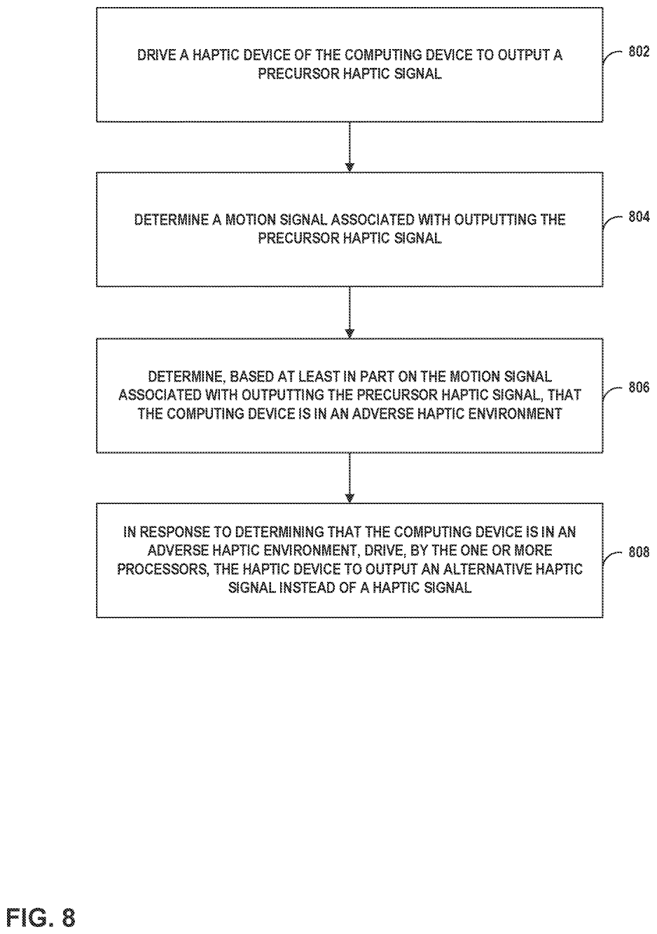

FIG. 8 is a flowchart illustrating example operations of an example computing device configured to output haptic signals, in accordance with one or more aspects of the present disclosure. For purposes of illustration only, the example operations are described below within the context of computing device 202 of FIG. 2.

As shown in FIG. 8, one or more processors 240 of computing device 202 may drive a haptic device 214 of the computing device 202 to output a precursor haptic signal (802). One or more processors 240 may determine a motion signal associated with outputting the precursor haptic signal (804). One or more processors 240 may determine, based at least in part on the motion signal of the computing device, that the computing device 202 is in an adverse haptic environment (806). One or more processors 240 may, in response to determining that the computing device 202 is in an adverse haptic environment, drive the haptic device 214 to output an alternative haptic signal instead of the haptic signal (808).

In some examples, computing device 202 includes a motion sensor 206 configured to sense motion of the computing device 202 while the haptic device 214 outputs at least a portion of the precursor haptic signal, and where to determine the motion signal associated with outputting the precursor haptic signal, one or more processors 240 may determine the motion signal associated with outputting the precursor haptic signal based at least in part on the motion of the computing device 202 sensed by the motion sensor.

In some examples, to sense the motion of the computing device 202, motion sensor 206 may sense the motion of the computing device 202 along an axis of the motion sensor 206 that corresponds to an axis of a linear resonant actuator of the haptic device 214 along which a mass of the haptic device 214 moves to output the precursor haptic signal.

In some examples, to determine, based at least in part on the motion signal of the computing device 202, that the computing device 202 is in the adverse haptic environment, the one or more processors 240 may determine, based at least in part on comparing the motion signal of the computing device 202 with a non-adverse motion signal, that the computing device 202 is in the adverse haptic environment.

In some examples, to compare the motion signal of the computing device 202 with the non-adverse motion signal, the one or more processors 240 may compare a magnitude of a peak amplitude of the motion signal in a frequency domain with a magnitude of a peak amplitude of the non-adverse motion signal in the frequency domain to determine that the computing device 202 is in the adverse haptic environment.

In some examples, to compare the peak amplitude of the motion signal in the frequency domain with the magnitude of the peak amplitude of the non-adverse motion signal in the frequency domain to determine that the computing device 202 is in the adverse haptic environment, the one or more processors 240 may determine that the magnitude of the peak amplitude of the motion signal in the frequency domain is greater than the magnitude of the peak amplitude of the non-adverse motion signal in the frequency domain and, in response to determining that the magnitude of the peak amplitude of the motion signal in the frequency domain is greater than the magnitude of the peak amplitude of the non-adverse motion signal in the frequency domain, the one or more processors 240 may determine that the computing device 202 is in the adverse haptic environment.

In some examples, to determine that the computing device 202 is in the adverse haptic environment, the one or more processors 240 may determine that the peak amplitude of the motion signal in the frequency domain occurs at a lower harmonic frequency compared with the peak amplitude of the motion signal and, in response to determining that the magnitude of the peak amplitude of the motion signal in the frequency domain is greater than the magnitude of the peak amplitude of the non-adverse motion signal in the frequency domain and that that the peak amplitude of the motion signal in the frequency domain occurs at a lower harmonic frequency compared with the peak amplitude of the motion signal, one or more processors 240 may determine that the computing device 202 is in the adverse haptic environment.

In some examples, the computing device includes one or more audio output devices configured to, while at least a portion of the alternative haptic signal is being outputted by the haptic device 214, output an audio signal that corresponds to an audio component of the haptic signal.

In some examples, the alternative haptic signal has a smaller vibration intensity compared to the haptic signal.

In some examples, to drive the haptic device 214 of the computing device 202 to output the precursor haptic signal, the one or more processors 240 may determine that one or more characteristics of the computing device indicate a likelihood that the computing device 202 is in the adverse haptic environment and, in response to determining that the one or more characteristics of the computing device 202 indicate the likelihood that the computing device 202 is in the adverse haptic environment, drive the haptic device 214 to output the precursor haptic signal.

This disclosure includes the following examples:
Example 1. A method comprising: driving, by one or more processors of a computing device, a haptic device of the computing device to output a precursor haptic signal; determining, by the one or more processors, a motion signal associated with outputting the precursor haptic signal; determining, by the one or more processors and based at least in part on the motion signal associated with outputting the precursor haptic signal, that the computing device is in an adverse haptic environment; and in response to determining that the computing device is in an adverse haptic environment, driving, by the one or more processors, the haptic device to output an alternative haptic signal instead of a haptic signal.
Example 2. The method of example 1, wherein determining the motion signal associated with outputting the precursor haptic signal further comprises: sensing, by a motion sensor of the computing device, motion of the computing device while the haptic device outputs at least a portion of the precursor haptic signal; and determining, by the one or more processors, the motion signal associated with outputting the precursor haptic signal based at least in part on the motion of the computing device sensed by the motion sensor.
Example 3. The method of example 2, wherein sensing the motion of the computing device further comprises: sensing, by the motion sensor of the computing device, the motion of the computing device along an axis of the motion sensor that corresponds to an axis of a linear resonant actuator of the haptic device along which a mass of the haptic device moves to output the precursor haptic signal.
Example 4. The method of any of examples 1-3, wherein determining, based at least in part on the motion signal of the computing device, that the computing device is in the adverse haptic environment further comprises: determining, by the one or more processors and based at least in part on comparing the motion signal of the computing device with a non-adverse motion signal, that the computing device is in the adverse haptic environment.
Example 5. The method of example 4, wherein comparing the motion signal of the computing device with the non-adverse motion signal further comprises: comparing, by the one or more processors, a magnitude of a peak amplitude of the motion signal in a frequency domain with a magnitude of a peak amplitude of the non-adverse motion signal in the frequency domain to determine that the computing device is in the adverse haptic environment.
Example 6. The method of example 5, wherein comparing the peak amplitude of the motion signal in the frequency domain with the magnitude of the peak amplitude of the non-adverse motion signal in the frequency domain to determine that the computing device is in the adverse haptic environment further comprises: determining, by the one or more processors, that the magnitude of the peak amplitude of the motion signal in the frequency domain is greater than the magnitude of the peak amplitude of the non-adverse motion signal in the frequency domain; and in response to determining that the magnitude of the peak amplitude of the motion signal in the frequency domain is greater than the magnitude of the peak amplitude of the non-adverse motion signal in the frequency domain, determining, by the one or more processors, that the computing device is in the adverse haptic environment.
Example 7. The method of example 6, wherein determining that the computing device is in the adverse haptic environment further comprises: determining, by the one or more processors, that the peak amplitude of the motion signal in the frequency domain occurs at a lower harmonic frequency compared with the peak amplitude of the motion signal; and in response to determining that the magnitude of the peak amplitude of the motion signal in the frequency domain is greater than the magnitude of the peak amplitude of the non-adverse motion signal in the frequency domain and that that the peak amplitude of the motion signal in the frequency domain occurs at a lower harmonic frequency compared with the peak amplitude of the motion signal, determining, by the one or more processors, that the computing device is in the adverse haptic environment.
Example 8. The method of any of examples 1-7, further comprising: while at least a portion of the alternative haptic signal is being outputted by the haptic device, outputting, by one or more audio output devices of the computing device, an audio signal that corresponds to an audio component of the haptic signal.
Example 9. The method of any of examples 1-8, wherein the alternative haptic signal has a smaller vibration intensity compared to the haptic signal.
Example 10. The method of any of examples 1-9, wherein driving the haptic device of the computing device to output the precursor haptic signal further comprises: determining, by the one or more processors, that one or more characteristics of the computing device indicate a likelihood that the computing device is in the adverse haptic environment; and in response to determining that the one or more characteristics of the computing device indicate the likelihood that the computing device is in the adverse haptic environment, driving, by the one or more processors, the haptic device to output the precursor haptic signal.
Example 11. A computing device comprising: a haptic device; a memory that stores instructions; and one or more processors that execute the instructions to: drive the haptic device to output a precursor haptic signal; determine a motion signal associated with outputting the precursor haptic signal; determine, based at least in part on the motion signal associated with outputting the precursor haptic signal, that the computing device is in an adverse haptic environment; and in response to determining that the computing device is in an adverse haptic environment, drive the haptic device to output an alternative haptic signal instead of a haptic signal.
Example 12. The computing device of example 11, wherein the computing device further includes a motion sensor configured to sense motion of the computing device while the haptic device outputs at least a portion of the precursor haptic signal, and wherein the one or more processors that execute the instructions to determine the motion signal associated with outputting the precursor haptic signal further execute the instructions to: determine the motion signal associated with outputting the precursor haptic signal based at least in part on the motion of the computing device sensed by the motion sensor.
Example 13. The computing device of example 12, wherein the motion sensor configured to sense the motion of the computing device is further configured to: sense the motion of the computing device along an axis of the motion sensor that corresponds to an axis of a linear resonant actuator of the haptic device along which a mass of the haptic device moves to output the precursor haptic signal.
Example 14. The computing device of any of examples 11-13, wherein the one or more processors that execute the instructions to determine, based at least in part on the motion signal of the computing device, that the computing device is in the adverse haptic environment further execute the instructions to: determine, based at least in part on comparing the motion signal of the computing device with a non-adverse motion signal, that the computing device is in the adverse haptic environment.
Example 15. The computing device of example 14, wherein the one or more processors that execute the instructions to compare the motion signal of the computing device with the non-adverse motion signal further execute the instructions to: compare a magnitude of a peak amplitude of the motion signal in a frequency domain with a magnitude of a peak amplitude of the non-adverse motion signal in the frequency domain to determine that the computing device is in the adverse haptic environment.
Example 16. The computing device of example 15, wherein the one or more processors that execute the instructions to compare the peak amplitude of the motion signal in the frequency domain with the magnitude of the peak amplitude of the non-adverse motion signal in the frequency domain to determine that the computing device is in the adverse haptic environment further execute the instructions to: determine that the magnitude of the peak amplitude of the motion signal in the frequency domain is greater than the magnitude of the peak amplitude of the non-adverse motion signal in the frequency domain; and in response to determining that the magnitude of the peak amplitude of the motion signal in the frequency domain is greater than the magnitude of the peak amplitude of the non-adverse motion signal in the frequency domain, determine that the computing device is in the adverse haptic environment.
Example 17. The computing device of example 16, wherein the one or more processors that execute the instructions to determine that the computing device is in the adverse haptic environment further execute the instructions to: determine that the peak amplitude of the motion signal in the frequency domain occurs at a lower harmonic frequency compared with the peak amplitude of the motion signal; and in response to determining that the magnitude of the peak amplitude of the motion signal in the frequency domain is greater than the magnitude of the peak amplitude of the non-adverse motion signal in the frequency domain and that that the peak amplitude of the motion signal in the frequency domain occurs at a lower harmonic frequency compared with the peak amplitude of the motion signal, determine that the computing device is in the adverse haptic environment.
Example 18. The computing device of any of examples 11-17, wherein the computing device includes one or more audio output devices configured to: while at least a portion of the alternative haptic signal is being outputted by the haptic device, output an audio signal that corresponds to an audio component of the haptic signal.
Example 19. The computing device of any of examples 11-18, wherein the alternative haptic signal has a smaller vibration intensity compared to the haptic signal.
Example 20. A non-transitory computer-readable storage medium storing instructions that, when executed, cause one or more processors of a computing device to: drive a haptic device of the computing device to output a precursor haptic signal; determine a motion signal associated with outputting the precursor haptic signal; determine, based at least in part on the motion signal associated with outputting the precursor haptic signal, that the computing device is in an adverse haptic environment; and in response to determining that the computing device is in an adverse haptic environment, drive, by the one or more processors, the haptic device to output an alternative haptic signal instead of a haptic signal.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

1. A method comprising:
driving, by one or more processors of a computing device, a haptic device of the computing device to output a precursor haptic signal;
determining, by the one or more processors, a motion signal associated with outputting the precursor haptic signal;
determining, by the one or more processors and based at least in part on the motion signal associated with outputting the precursor haptic signal, that the computing device is in an adverse haptic environment; and
in response to determining that the computing device is in an adverse haptic environment, driving, by the one or more processors, the haptic device to output an alternative haptic signal instead of a haptic signal.

2. The method of claim 1, wherein determining the motion signal associated with outputting the precursor haptic signal further comprises:
sensing, by a motion sensor of the computing device, motion of the computing device while the haptic device outputs at least a portion of the precursor haptic signal; and
determining, by the one or more processors, the motion signal associated with outputting the precursor haptic signal based at least in part on the motion of the computing device sensed by the motion sensor.

3. The method of claim 2, wherein sensing the motion of the computing device further comprises:
sensing, by the motion sensor of the computing device, the motion of the computing device along an axis of the motion sensor that corresponds to an axis of a linear resonant actuator of the haptic device along which a mass of the haptic device moves to output the precursor haptic signal.

4. The method of claim 1, wherein determining, based at least in part on the motion signal of the computing device, that the computing device is in the adverse haptic environment further comprises:
determining, by the one or more processors and based at least in part on comparing the motion signal of the computing device with a non-adverse motion signal, that the computing device is in the adverse haptic environment.

5. The method of claim 4, wherein comparing the motion signal of the computing device with the non-adverse motion signal further comprises:
comparing, by the one or more processors, a magnitude of a peak amplitude of the motion signal in a frequency domain with a magnitude of a peak amplitude of the non-adverse motion signal in the frequency domain to determine that the computing device is in the adverse haptic environment.

6. The method of claim 5, wherein comparing the peak amplitude of the motion signal in the frequency domain with the magnitude of the peak amplitude of the non-adverse motion signal in the frequency domain to determine that the computing device is in the adverse haptic environment further comprises:
determining, by the one or more processors, that the magnitude of the peak amplitude of the motion signal in the frequency domain is greater than the magnitude of the peak amplitude of the non-adverse motion signal in the frequency domain; and
in response to determining that the magnitude of the peak amplitude of the motion signal in the frequency domain is greater than the magnitude of the peak amplitude of the non-adverse motion signal in the frequency domain, determining, by the one or more processors, that the computing device is in the adverse haptic environment.

7. The method of claim 6, wherein determining that the computing device is in the adverse haptic environment further comprises:
determining, by the one or more processors, that the peak amplitude of the motion signal in the frequency domain occurs at a lower harmonic frequency compared with the peak amplitude of the motion signal; and
in response to determining that the magnitude of the peak amplitude of the motion signal in the frequency domain is greater than the magnitude of the peak amplitude of the non-adverse motion signal in the frequency domain and that that the peak amplitude of the motion signal in the frequency domain occurs at a lower harmonic frequency compared with the peak amplitude of the motion signal, determining, by the one or more processors, that the computing device is in the adverse haptic environment.

8. The method of claim 1, further comprising:
while at least a portion of the alternative haptic signal is being outputted by the haptic device, outputting, by one or more audio output devices of the computing device, an audio signal that corresponds to an audio component of the haptic signal.

9. The method of claim 1, wherein the alternative haptic signal has a smaller vibration intensity compared to the haptic signal.

10. The method of claim 1, wherein driving the haptic device of the computing device to output the precursor haptic signal further comprises:
determining, by the one or more processors, that one or more characteristics of the computing device indicate a likelihood that the computing device is in the adverse haptic environment; and
in response to determining that the one or more characteristics of the computing device indicate the likelihood that the computing device is in the adverse haptic environment, driving, by the one or more processors, the haptic device to output the precursor haptic signal.

11. A computing device comprising:
a haptic device;
a memory that stores instructions; and
one or more processors that execute the instructions to:
drive the haptic device to output a precursor haptic signal;
determine a motion signal associated with outputting the precursor haptic signal;
determine, based at least in part on the motion signal associated with outputting the precursor haptic signal, that the computing device is in an adverse haptic environment; and
in response to determining that the computing device is in an adverse haptic environment, drive the haptic device to output an alternative haptic signal instead of a haptic signal.

12. The computing device of claim 11, wherein the computing device further includes a motion sensor configured to sense motion of the computing device while the haptic device outputs at least a portion of the precursor haptic signal, and wherein the one or more processors that execute the instructions to determine the motion signal associated with outputting the precursor haptic signal further execute the instructions to:
determine the motion signal associated with outputting the precursor haptic signal based at least in part on the motion of the computing device sensed by the motion sensor.

13. The computing device of claim 12, wherein the motion sensor configured to sense the motion of the computing device is further configured to:
sense the motion of the computing device along an axis of the motion sensor that corresponds to an axis of a linear resonant actuator of the haptic device along which a mass of the haptic device moves to output the precursor haptic signal.

14. The computing device of claim 11, wherein the one or more processors that execute the instructions to determine, based at least in part on the motion signal of the computing device, that the computing device is in the adverse haptic environment further execute the instructions to:
determine, based at least in part on comparing the motion signal of the computing device with a non-adverse motion signal, that the computing device is in the adverse haptic environment.

15. The computing device of claim 14, wherein the one or more processors that execute the instructions to compare the motion signal of the computing device with the non-adverse motion signal further execute the instructions to:
compare a magnitude of a peak amplitude of the motion signal in a frequency domain with a magnitude of a peak amplitude of the non-adverse motion signal in the frequency domain to determine that the computing device is in the adverse haptic environment.

16. The computing device of claim 15, wherein the one or more processors that execute the instructions to compare the peak amplitude of the motion signal in the frequency domain with the magnitude of the peak amplitude of the non-adverse motion signal in the frequency domain to determine that the computing device is in the adverse haptic environment further execute the instructions to:
determine that the magnitude of the peak amplitude of the motion signal in the frequency domain is greater than the magnitude of the peak amplitude of the non-adverse motion signal in the frequency domain; and
in response to determining that the magnitude of the peak amplitude of the motion signal in the frequency domain is greater than the magnitude of the peak amplitude of the non-adverse motion signal in the frequency domain, determine that the computing device is in the adverse haptic environment.

17. The computing device of claim 16, wherein the one or more processors that execute the instructions to determine that the computing device is in the adverse haptic environment further execute the instructions to:
determine that the peak amplitude of the motion signal in the frequency domain occurs at a lower harmonic frequency compared with the peak amplitude of the motion signal; and
in response to determining that the magnitude of the peak amplitude of the motion signal in the frequency domain is greater than the magnitude of the peak amplitude of the non-adverse motion signal in the frequency domain and that that the peak amplitude of the motion signal in the frequency domain occurs at a lower harmonic frequency compared with the peak amplitude of the motion signal, determine that the computing device is in the adverse haptic environment.

18. The computing device of claim 11, wherein the computing device includes one or more audio output devices configured to:
while at least a portion of the alternative haptic signal is being outputted by the haptic device, output an audio signal that corresponds to an audio component of the haptic signal.

19. The computing device of claim 11, wherein the alternative haptic signal has a smaller vibration intensity compared to the haptic signal.

20. A non-transitory computer-readable storage medium storing instructions that, when executed, cause one or more processors of a computing device to:
drive a haptic device of the computing device to output a precursor haptic signal;
determine a motion signal associated with outputting the precursor haptic signal;
determine, based at least in part on the motion signal associated with outputting the precursor haptic signal, that the computing device is in an adverse haptic environment; and
in response to determining that the computing device is in an adverse haptic environment, drive, by the one or more processors, the haptic device to output an alternative haptic signal instead of a haptic signal.
